(19) United States
(12) Patent Application Publication
(10) Pub. No.: US 2014/0266532 A1
(43) Pub. Date: Sep. 18, 2014

(54) LINE, SPIRAL INDUCTOR, MEANDER INDUCTOR, AND SOLENOID COIL

(71) Applicant: Kabushiki Kaisha Toshiba, Minato-ku (JP)

(72) Inventor: Keiju YAMADA, Yokohama-shi (JP)

(73) Assignee: Kabushiki Kaisha Toshiba, Minato-ku (JP)

(21) Appl. No.: 14/039,028

(22) Filed: Sep. 27, 2013

(30) Foreign Application Priority Data
Mar. 15, 2013 (JP) 2013-054062
Sep. 25, 2013 (JP) 2013-199056

(51) Int. Cl. H01F 5/00

(52) U.S. Cl. CPC H01F 5/00
USPC 336/175; 174/126.1

(57) ABSTRACT

According to one embodiment, a line is provided. The line includes a center conductor and a covering portion. The covering portion covers the center conductor. The covering portion includes at least one layer that is made of a soft magnetic material and is thinner than a skin depth at a frequency where supply of a signal or power is performed.

### CROSS-REFERENCE TO RELATED APPLICATIONS

This application is based upon and claims the benefit of priority from the prior Japanese Patent Application No. 2013-054062, filed Mar. 15, 2013, and No. 2013-199056, filed Sep. 25, 2013, the entire contents all of which are incorporated herein by reference.

### FIELD

Embodiments described herein relate generally to a line, a planar spiral inductor, a meander inductor, and a solenoid coil.

### BACKGROUND

In the past, a switching power supply device used in a communication device such as a notebook computer has been required to increase a switching frequency. As the increase in the switching frequency, for example, it is required to use a frequency of megahertz (MHz) band.

In this regard, a switching power supply device using a frequency of kilohertz (kHz) band employs an inductor using ferrite as a bobbin. If this inductor is employed in a switching power supply device using a frequency of megahertz (MHz), iron loss is increased.

Also, in the switching power supply device, noise of hundreds of MHz to several gigahertz (GHz) is generated by a resonance of a circuit.

### BRIEF DESCRIPTION OF THE DRAWING

FIG. 1 is a perspective view showing a line according to a first embodiment;

FIG. 2 is a cross-sectional view of the line;

FIG. 3 is a cross-sectional view showing another form of the line;

FIG. 4 is a perspective view showing a state in which the line is fixed to a substrate;

FIG. 5 is a graph showing values of a real part and an imaginary part of a relative permeability with respect to a frequency in the line;

FIG. 6 is a graph showing an analysis result of frequency characteristics of inductances of the line and a comparative line;

FIG. 7 is a graph showing a frequency characteristic of Ploss/Pin that is a noise suppression indicator of the line;

FIG. 8 is a graph showing an analysis result of frequency characteristics of inductances in the line when a relative permeability of a soft magnetic material of a covering portion and a conductivity of the soft magnetic material of the covering portion are changed;

FIG. 9 is a graph showing a relationship between σ/σ′ and L/Lmax;

FIG. 10 is a graph showing a variation of Ploss/Pin with respect to a variation of a sheet resistance in the line;

FIG. 11 is a cross-sectional view showing a line according to a second embodiment;

FIG. 12 is a graph showing a frequency characteristic of a relative permeability of NiZn ferrite used in the line;

FIG. 13 is a graph showing inductances of lines of first to fifth patterns with respect to frequency;

FIG. 14 is a graph showing a frequency characteristic of Ploss/Pin in the first to fifth lines;

FIG. 15 is a perspective view showing a spiral inductor according to a third embodiment;

FIG. 16 is a graph showing frequency characteristics of inductances of first to third spiral inductors;

FIG. 17 is a graph showing a frequency characteristic of Ploss/Pin that is a noise suppression indicator of the first to third spiral inductors;

FIG. 18 is a plan view showing a meander inductor according to a fourth embodiment;

FIG. 19 is a graph showing inductances of first and second meander inductors with respect to frequency;

FIG. 20 is a graph showing a frequency characteristic of Ploss/Pin that is a noise suppression indicator of the first and second meander inductors;

FIG. 21 is a perspective view showing a solenoid coil according to a fifth embodiment;

FIG. 22 is a graph showing frequency characteristics of inductances of first and second solenoid coils; and

FIG. 23 is a graph showing a frequency characteristic of Ploss/Pin that is a noise suppression indicator of the first and second solenoid coils.

### DETAILED DESCRIPTION

In general, according to one embodiment, a line includes a center conductor and a covering portion. The covering portion covers the center conductor. The covering portion includes at least one layer that is made of a soft magnetic material and is thinner than a skin depth at a frequency where supply of a signal or power is performed.

A line according to a first embodiment will be described below with reference to FIGS. 1 to 10. FIG. 1 is a perspective view showing a line 10 of the present embodiment. FIG. 2 is a cross-sectional view of the line 10 shown in FIG. 1. As shown in FIGS. 1 and 2, the line 10 includes a center conductor 20, and a covering portion 30 that covers the center conductor 20.

It is preferable that the center conductor 20 is made of a high-conductivity material in order to reduce an electrical resistance. Examples of the high-conductivity material include copper (Cu), silver (Ag), gold (Au), and aluminum (Al).

The covering portion 30 covers the center conductor 20. Also, as shown in FIG. 2, a cross-sectional shape of the center conductor 20 is, for example, rectangular. The covering portion 30 has a constant thickness value at any position. Therefore, an outer shape of the covering portion 30 is also rectangular. The covering portion 30 is made of a soft magnetic material. As an example of the present embodiment, the soft magnetic material is amorphous CoNbZr or CoFeB, granular CoZrO or CoAlO, or polycrystalline NiFe.

In the present embodiment, the covering portion 30 has a single-layer structure. The single-layer structure refers to a structure that includes one layer made of a soft magnetic material. In a structure in which the covering portion 30 has two or more layers, the covering portion 30 includes a plurality of stacked layers made of a soft magnetic material.

Also, the line 10 may include an insulating layer made of an insulating material in the periphery of the covering portion 30 in order to prevent short circuit.

A thickness of the covering portion 30 will be described below in detail. When assuming that f1 is a frequency at which the thickness tm of the soft magnetic material and the skin depth δ of the covering portion 30 become equal to each other, the frequency f1 is set to be higher than a frequency at which signal transmission or power transmission is performed using the line 10. When assuming that f2 is a ferromagnetic resonance frequency of the soft magnetic material and f3 is a lower-limit frequency of a frequency band being a noise component occurring in the line 10, the frequency f1 is set to be lower than the lower-limit frequency f3 and the ferromagnetic resonance frequency f2.

The skin depth δ of the covering portion 30 is expressed as Math. (1) below.

$$δ = \sqrt{\frac{1}{π f {σμ}_{0} {μ}_{r}}} \qquad [ Math . 1 ]$$

f is a frequency, σ is a conductivity of the soft magnetic material, μ0 is a vacuum permeability, and μr is a complex relative permeability of the soft magnetic material forming the covering portion 30. Also, μr′ is a value of a real part of the complex relative permeability μr of the soft magnetic material forming the covering portion 30, and μr″ is a value of an imaginary part of the complex relative permeability μr of the soft magnetic material forming the covering portion 30.

FIG. 5 is a graph showing values of a real part μr′ and an imaginary part μr″ with respect to frequency. In FIG. 5, a horizontal axis represents a frequency, and a vertical axis represents a permeability. In FIG. 5, the real part μr′ is indicated by a solid line, and the imaginary part μr″ is indicated by a chain line.

When the frequency f is lower than the above-described frequency f1 at which the skin depth of the covering portion 30 and the thickness of the covering portion 30 become equal to each other, a current flows through the center conductor 20, of which the conductivity σ is higher than that of the covering portion 30. Since a resistance of the center conductor 20 is small, a transmission loss is also low.

Therefore, loss can be reduced in such a manner that a frequency band used for signal transmission or power supply is set to be lower than the frequency f1 at which the skin depth δ of the soft magnetic material forming the above-described covering portion 30 and the thickness tm of the covering portion 30 become equal to each other.

Also, a frequency higher than the frequency f1 at which the skin depth of the covering portion 30 and the thickness of the covering portion 30 become equal to each other mainly becomes a conductive noise. A current of a frequency higher than the frequency at which the skin depth of the covering portion 30 and the thickness of the covering portion 30 become equal to each other flows through the covering portion 30 due to a skin effect. That is, the conductive noise flows through the soft magnetic material. Since the covering portion 30 is made of the soft magnetic material, a conductivity of the covering portion 30 is lower than that of the center conductor 20, and thus, a resistance of the covering portion 30 is increased. For this reason, loss of the current flowing through the covering portion 30 is increased.

Also, at the ferromagnetic resonance frequency f2 of the soft magnetic material forming the covering portion 30, the value μr″ of the imaginary part of the complex relative permeability μr of the soft magnetic material forming the covering portion 30 is maximized, and an absolute value of the complex relative permeability μr of the soft magnetic material is also maximized. Therefore, when the frequency becomes the ferromagnetic resonance frequency f2, the skin depth δ is minimized, and the line 10 has a very high resistance, that is, a high loss characteristic, with respect to the current.

In the present embodiment, it is possible to obtain a line that has a low loss in a frequency band used for signal transmission or power supply and has a high loss in a frequency band in which a conductive noise flows, in such a manner that the ferromagnetic resonance frequency f2 of the soft magnetic material forming the covering portion 30 is set to be higher than the frequency f1 at which the skin depth δ of the covering portion 30 and the thickness tm of the covering portion 30 become equal to each other.

In the present embodiment, for example, the cross-sectional shape of the center conductor 20 is rectangular as shown in FIG. 2. In order to prevent a reduction in permeability due to magnetic saturation, the cross-sectional shape of the center conductor 20 is formed such that a magnetic field intensity applied to the covering portion 30 is smaller than a value of an anisotropic magnetic field of the soft magnetic material. The magnetic field intensity applied to the covering portion 30 may be calculated according to the Ampere's law. For example, when the cross-section of the center conductor 20 is a circle diameter and a diameter thereof is d, the magnetic field intensity H applying a current having a current value I to the covering portion 30 is H=I/(π×d) according to the Ampere's Law. As a method other than the use of the Ampere's Law, the magnetic field intensity H may also be obtained by an electromagnetic simulation.

Next, the result of analyzing a frequency characteristic of an inductance of the line 10 will be described. In this analysis, the line 10 is formed to transmit a signal having a frequency of 10 MHz or less and suppress a transmission noise having a frequency of 300 MHz or more.

Specifically, the covering portion 30 is made of Co₈₅Nb₁₂Zr₃ in which a real part of a relative permeability in a hard axis direction of a uniaxial anisotropy has 1000 in DC. Co₈₅Nb₁₂Zr₃ is an example of the soft magnetic material. The conductivity of Co₈₅Nb₁₂Zr₃ is 8.3×10 S/m. The ferromagnetic resonance frequency f2 of Co₈₅Nb₁₂Zr₃ is 890 MHz.

When the frequency f1 at which the skin depth δ of the covering portion 30 becomes the thickness tm of the covering portion 30 is 300 MHz, the skin depth δ of the covering portion 30 at 300 MHz becomes 1.0 μm. Hence, the thickness tm of the covering portion 30 is set to 1.0 μm.

The soft magnetic material forming the covering portion 30 has a characteristic of high permeability when a direction of applying a high-frequency magnetic field with a uniaxial magnetic anisotropy is a hard axis direction. In the present embodiment, in the covering portion 30, an easy axis of the uniaxial magnetic anisotropy is induced along a linear direction in which the line 10 extends.

FIG. 4 shows the line 10 used in this analysis. FIG. 4 shows a state in which the line 10 is fixed on a substrate 40. A material of the substrate 40 is a flame retardant type 4 (FR-4). A thickness of the substrate 40 is 0.1 mm.

Herein, a direction is defined. An extending direction of the line 10 is defined as x-axis. A direction perpendicular to the x axis and parallel to a surface of the substrate 40 is defined as y-axis. A direction perpendicular to the surface 41 of the substrate 40 is defined as z-axis. The x-axis, the y-axis, and the z-axis are perpendicular to one another.

The center conductor 20 of the line 10 is made of copper (Cu), and has a length of 10 mm, a width of 0.158 mm, and a thickness of 0.035 mm. The covering portion 30 is made of Co₈₅Nb₁₂Zr₃ as described above, and has a thickness of 1 μm. In the covering portion 30, the easy axis direction of the uniaxial magnetic anisotropy is induced in the x-axis direction. Therefore, the x-axis, y-axis, and z-axis permeability (μx, μy, μz) of the covering portion 30 becomes (1, μr, μr). Also, μx is the permeability of the x-axis direction, μy is the permeability of the y-axis direction, and μz is the permeability of the z-axis direction.

Also, for comparison, an inductance of a comparative line was analyzed. The comparative line has no covering portion 30 and has only a center conductor 20. The center conductor 20 of the comparative line has a length of 10 μm, a width of 0.16 mm, and a thickness of 0.37 mm. As such, the outer shape of the comparative line is identical to that of the line 10.

FIG. 6 is a graph showing an analysis result of inductances of the line 10 and the comparative line with respect to frequency. In FIG. 6, a horizontal axis represents a frequency, and a vertical axis represents an inductance. In FIG. 6, a characteristic of the line 10 is indicated by a solid line, and a characteristic of the comparative line is indicated by a chain line. As shown in FIG. 6, the inductance of the line 10 is 34 nH at 120 MHz or less and is approximately constant. The comparative line is 3.4 nH at 120 MHz or less and is approximately constant. As such, at 120 MHz or less, the line 10 has about ten times the inductance value of the comparative line.

FIG. 7 is a graph showing a frequency characteristic of Ploss/Pin that is a noise suppression indicator of the line 10. Pin is an amount of energy input to the line 10, and Ploss is an amount of energy consumed in the line 10. In FIG. 7, a frequency characteristic of the line 10 is indicated by a solid line, and a frequency characteristic of the comparative line made of only a conductor is indicated by a chain line.

As shown in FIG. 7, in the line 10, Ploss/Pin is 35% or more in a band ranging from 300 MHz to 5 GHz. Also, at 1500 MHz, Ploss/Pin is 54%.

On the other hand, in the comparative line made of only the conductor, Ploss/Pin is approximately 0% at 1 GHz or less.

Also, the inductance of the line 10 is determined by the frequency f, the permeability μr of the soft magnetic material forming the covering portion 30, and the conductivity σ of the soft magnetic material. The inductance L of the line 10 was analyzed when the frequency f, the permeability μr of the soft magnetic material of the covering portion 30, and the conductivity σ of the soft magnetic material forming the covering portion 30 was changed in the line 10. FIG. 8 is a graph showing the analysis result.

In FIG. 8, first to eighth patterns are analyzed. The permeability μr and frequency f of each of the first to eighth patterns are differently set, and the conductivity σ of each of the first to eighth patterns is changed. In FIG. 8 a horizontal axis represents the conductivity σ of the soft magnetic material, and a vertical axis represents the inductance L. In the analysis shown in FIG. 8, the conductivity σ of the soft magnetic material in the first to eighth patterns is changed in a range between 1.0×10⁴S/m and 5.0×10⁷S/m.

Also, the lines of the first to eighth patterns have the same shape as the line 10 shown in FIG. 1 and are fixed to the substrate 40 as shown in FIG. 4.

In the lines of the first to eighth patterns, the easy axis direction of the uniaxial magnetic anisotropy of the covering portion 30 is induced in the extending direction of each line, that is, the x-axis direction.

The relative permeability μr and the frequency f of the first to eighth patterns will be described below in detail. In the first pattern, the relative permeability μr of the soft magnetic material of the covering portion 30 is 100 and the frequency f is 30 MHz. In the second pattern, the relative permeability μr of the soft magnetic material of the covering portion 30 is 100 and the frequency f is 100 MHz. In the third pattern, the relative permeability μr of the soft magnetic material of the covering portion 30 is 300 and the frequency f is 10 MHz.

In the fourth pattern, the relative permeability μr of the soft magnetic material of the covering portion 30 is 300 and the frequency f is 30 MHz. In the fifth pattern, the relative permeability μr of the soft magnetic material of the covering portion 30 is 300 and the frequency f is 100 MHz. In the sixth pattern, the relative permeability μr of the soft magnetic material of the covering portion 30 is 1000 and the frequency f is 10 MHz. In the seventh pattern, the relative permeability μr of the soft magnetic material of the covering portion 30 is 1000 and the frequency f is 30 MHz. In the eighth pattern, the relative permeability μr of the soft magnetic material of the covering portion 30 is 1000 and the frequency f is 100 MHz.

In FIG. 8, the analysis result of the first pattern is indicated by a chain line, the analysis result of the second pattern is indicated by a two-dot chain line, the analysis result of the third pattern is indicated by a three-dot chain line, the analysis result of the four pattern is indicated by a four-dot chain line, the analysis result of the fifth pattern is indicated by a five-dot chain line, the analysis result of the sixth pattern is indicated by a six-dot chain line, the analysis result of the seventh pattern is indicated by a seven-dot chain line, and the analysis result of the eighth pattern is indicated by an eight-dot chain line.

As shown in FIG. 8, in the first and second patterns, the value of the inductance L is approximately constant and is not changed. Also, the inductances L of the first and second patterns are approximately equal to each other. On the other hand, in the third and fourth patterns, it can be seen that the inductance L is high when the conductivity σ of the soft magnetic material is low, and the inductance L is lowered as the conductivity σ is increased.

In FIG. 8, it is assumed that Lmax is the inductance of the line when the conductivity σ of the soft magnetic material is 1.0×10⁴S/m, and σ′ is the conductivity of the soft magnetic material at which the skin depth δ of the soft magnetic material and the thickness tm of the soft magnetic material become equal to each other. f, μr, tm, and σ′ have a relationship expressed as Math. (2) below.

$${t}_{m} = \sqrt{\frac{1}{π f {μ}_{0} {μ}_{r} {σ}^{′}}} \qquad [ Math . 2 ]$$

A relationship between σ/σ′ and L/Lmax is shown in FIG. 9. In FIG. 9, a horizontal axis represents σ/σ′. A vertical axis represents L/Lmax. In FIG. 9, the first to eighth patterns are shown in the same manner as in FIG. 8.

Referring to FIG. 9, in a range of σ/σ′≦0.4, curves are overlapped for any value of f and μr, and L/Lmax≧0.9. Curves L1, L2 and L3 of FIG. 10 will be described below. The curve L1 is a curve in which the chain line indicating the first pattern and the two-dot chain line indicating the second patterns are overlapped with each other. The curve L2 is a curve in which the three-dot, four-dot and five-dot chain lines indicating the third, fourth and fifth patterns are overlapped with one another. The curve L3 is a curve in which the six-dot, seven-dot and eight-dot chain lines indicating the sixth, seventh and eighth patterns are overlapped with one another. Therefore, when σ/σ′≦0.4, that is, tm≦0.635, the inductance L becomes a high value of 0.9 times or more of Lmax.

Also, in a high-frequency band, Ploss/Pin, which is a ratio of energy input to the line 10 to energy consumed in the line 10, is determined by a sheet resistance of the soft magnetic material of the covering portion 30. Herein, a variation of Ploss/Pin with respect to a variation of the sheet resistance at 1 GHz was analyzed using the line 10 shown in FIG. 4.

FIG. 10 is a graph showing a variation of Ploss/Pin with respect to a variation of the sheet resistance. In FIG. 10, a horizontal axis represents the sheet resistance, and a vertical axis represents Ploss/Pin. In the line 10, the uniaxial magnetic anisotropy is induced in the extending direction of the line 10, and the x-axis, y-axis, and z-axis permeability is (1, μr, μr). The relative permeability μr is a complex relative permeability and uses a value at 1 GHz which is exhibited in the frequency characteristic shown in FIG. 5.

As shown in FIG. 10, Ploss/Pin is 10% or more when the sheet resistance is 0.04Ω or more, and Ploss/Pin becomes a maximum value of 52% when the sheet resistance is 1 Ω.

In the present embodiment, the cross-sectional shape of the line 10 is rectangular as shown in FIG. 2. As another example, as shown in FIG. 3, the cross-sectional shape of the line 10 may be a circle. In this case, as an example, the center conductor 20 is a circle with a constant radius, and the covering portion 30 has a constant thickness. Thus, the cross-sectional shape of the line 10 becomes a circle with a constant radius.

Also, in the present embodiment, as an example, the line 10 used in a circuit of which the operating frequency of signal or power transmission is MHz band has been described. As another example, the line 10 may be used in a motor of which the operating frequency is lower than 1 MHz, an IC of which the operating frequency is higher than 1 GHz, or the like.

In a case where the line 10 is used in a circuit such as a motor of which the operating frequency is lower than 1 MHz, the skin depth of the covering portion 30 becomes thick. Thus, the thickness of the covering portion 30 is increased. Also, in a case where the line 10 is used in an IC of which the operating frequency is higher than 1 GHz, the skin depth of the covering portion becomes thin. Thus, the thickness of the covering portion is reduced.

Also, in a case where the line 10 is used in a circuit such as a motor of which the operating frequency is lower than 1 MHz, a high noise suppression effect is obtained when the covering portion is formed using a soft magnetic material having a low ferromagnetic resonance frequency. Also, in a case where the line 10 is used in an IC of which the operating frequency is higher than 1 GHz, a high noise suppression effect is obtained when the covering portion is formed using a soft magnetic material having a high ferromagnetic resonance frequency.

Also, even when an insulating layer is inserted between the center conductor 20 and the covering portion 30 in order to prevent diffusion of atoms or molecules, the same inductance increase effect and noise suppression effect as described above is obtained by an proximity effect

Next, a line according to a second embodiment will be described with reference to FIGS. 11 to 14. Also, in the present embodiment, configurations having the same functions as the first embodiment are assigned with the same reference numerals as the first embodiment, and a description thereof will be omitted. In the present embodiment, the covering portion 30 has a plurality of layers. Also, the shape of the line 10 is different from that of the first embodiment. The differences will be described below in detail.

FIG. 11 is a cross-sectional view showing the line 10 of the present embodiment. It is preferable that the center conductor 20 is made of a material having a high conductivity in order to reduce an electrical resistance. In the present embodiment, as an example, the center conductor 20 is made of any one of copper (Cu), silver (Ag), gold (Au), and aluminum (Al).

The covering portion 30 covers the center conductor 20 such that the thickness from the center conductor 20 becomes constant. The covering portion 30 includes a first layer 31 and a second layer 32. The first layer 31 covers the center conductor 20. The thickness of the first layer 31 is constant.

The first layer 31 is made of a conductive soft magnetic material having a conductivity of 1 S/m or more, or an insulating soft magnetic material. The soft magnetic material forming the first layer 31 is either of amorphous CoNbZr and CoFeB, either of granular CoZrO and CoAlO, or either of NiZn ferrite and MnZn ferrite.

The second layer 32 covers the first layer 31. The second layer 32 contacts with the first layer 31. The thickness of the second layer 32 is constant. Therefore, the cross-sectional shape of the second layer 32 is a regular octagon. The second layer 32 is made of a conductive soft magnetic material of 1 S/m or more, or an insulating soft magnetic material. The soft magnetic material forming the second layer 32 is either of amorphous CoNbZr and CoFeB, or either of granular CoZrO and CoAlO.

In a low-frequency band for signal or power transmission, a magnetic field applied to the first layer 31 and the second layer 32 by a current flowing through the center conductor is higher in the first layer 31 disposed inside the line than in the second layer 32 disposed outside the line by the Ampere's law. Therefore, considering the magnetic saturation of the magnetic material, the anisotropic magnetic field of the second layer 32 can be made smaller than the anisotropic magnetic field of the first layer 31. Also, since the permeability is obtained by dividing a saturation magnetic flux density by an anisotropic magnetic field, there are many cases that the relative permeability of the second layer 32 having a low anisotropic magnetic field is higher than the relative permeability of the first layer 31.

Therefore, the soft magnetic material, which cannot be used in the first layer 31 in terms of the magnetic saturation, can be used in the second layer 32.

When it is assumed that f4 is a frequency at which a skin depth δ1 of the first layer 31 and a thickness tm1 of the first layer 31 become equal to each other and f5 is a frequency at which a skin depth δ2 of the second layer 32 and a thickness tm2 of the second layer 32 become equal to each other, a frequency band applied to the line 10 of the present embodiment for signal or power transmission is lower than the frequencies f4 and f5.

Also, the line 10 has a high noise suppression effect in a frequency band higher than a lower one of the frequencies f4 and f5. Also, the line 10 suppresses a frequency component in which a value of an imaginary part μr″ of the relative permeability μr of the first and second layers 31 and 32 increases. That is, the line 10 has a high noise suppression effect.

Regarding first to fifth lines, the analysis results of inductances with respect to frequency and Ploss/Pin with respect to frequency will be described below. First, the first to fifth lines will be described below.

The first line has only the center conductor 20 and has no covering portion 30. The center conductor 20 is made of copper (Cu).

The second line has the center conductor 20 and the covering portion 30. The center conductor 20 of the second line is made of copper (Cu). The covering portion 30 of the second line has only one layer. Therefore, the second line has the same configuration as the line 10 described in the first embodiment.

The third line has the center conductor 20 and the covering portion 30. The center conductor 20 of the third line is made of copper (Cu). The covering portion 30 of the third line has the first and second layers 31 and 32. The third line has the same configuration as the line 10 described with reference to FIG. 11. The first layer 31 of the third line is made of CoAlO that is a soft magnetic material. The second layer 32 is made of CoNbZr that is a soft magnetic material.

The fourth line has the center conductor 20 and the covering portion 30. The center conductor 20 of the fourth line is made of copper (Cu). The covering portion 30 of the fourth line has only one layer. That is, the fourth line has the same configuration as the line 10 described in the first embodiment. The covering portion 30 of the fourth line is made of NiZn ferrite that is an insulating soft magnetic material.

The fifth line has the center conductor 20 and the covering portion 30. The center conductor 20 of the fifth line is made of copper (Cu). The covering portion 30 of the fifth line has the first and second layers 31 and 32. The fifth line has the same configuration as the line 10 shown in FIG. 11. The first layer 31 is made of NiZn ferrite, and the second layer 32 is made of CoNbZr.

In the analysis of the inductance and Ploss/Pin, the dimensions of the cross-sectional shapes of the first to fifth lines are set. In the center conductors of the first to fifth lines, a distance from each apex to the farthest apex is 0.1 mm. In the second to fifth lines, a thickness L2 of the first layer 31 is 0.05 mm. A thickness of the second layers 32 of the third and fifth lines is 1 μm.

In the second and third lines, the relative permeability of CoAlO, which is the soft magnetic material, induces the uniaxial magnetic anisotropy in an extending direction of the line. Therefore, the x-axis, y-axis, and z-axis relative permeability (μx, μy, μz) is (1, 60, 60). Also, the x-axis direction is an extending direction of the line, the y-axis direction is a width direction of the line, and the z-axis direction is a height direction of the line. The conductivity of the first layer 31 was set to 10³S/m. The frequency f4 at which the skin depth δ1 and the thickness tm1 of the first layer 31 become equal to each other is 1700 MHz.

In the fourth and fifth lines, the relative permeability of the NiZn ferrite, which is the soft magnetic material, is set to all of the x-axis direction, the y-axis direction, and the z-axis direction. A frequency characteristic of the relative permeability of the NiZn ferrite is shown in FIG. 12. Also, in FIG. 12, a horizontal axis represents the frequency, and a vertical axis represents the relative permeability. In FIG. 12, a frequency characteristic of the real part of the relative permeability of the NiZn ferrite is indicated by a solid line. A frequency characteristic of the imaginary part of the relative permeability of the NiZn ferrite is indicted by a chain line.

CoNbZr, which is the soft magnetic material forming the second layers 32 of the third and fifth lines, induces the easy axis direction of the uniaxial magnetic anisotropy in the extending direction of the line. The x-axis, y-axis, and z-axis relative permeability (μx, μy, μz) of the second layers 32 of the third and fifth lines is (1, μr, μr). The frequency characteristic of the relative permeability μr has the frequency characteristic described in the first embodiment with reference to FIG. 5. In the third and fifth lines, the frequency at which the skin depth δ2 and the thickness tm2 of the second layer 32 become equal to each other, that is, the frequency f5 at which the skin depth of the second layer 32 becomes 1 μm, is 300 MHz.

FIG. 13 shows the inductances L of the first to fifth lines with respect to the frequency f. In FIG. 13, a horizontal axis represents the frequency, and a vertical axis represents the inductance. In FIG. 13, the frequency characteristic of the first line is indicated by a chain line, the frequency characteristic of the second line is indicated by a two-dot chain line, the frequency characteristic of the third line is indicated by a three-dot chain line, the frequency characteristic of the fourth line is indicated by a four-dot chain line, and the frequency characteristic of the fifth line is indicated by a five-dot chain line.

As shown in FIG. 13, in the second to fifth lines, it can be seen that the inductance is high in a low-frequency band in which the skin depth of the covering portion 30 is thicker than the thickness of the covering portion. This point will be described below in detail. In the first line having no covering portion 30, when the frequency is 10 MHz, the inductance is 11 nH. In the second line, when the frequency is 10 MHz, the inductance is 93 nH. In the third line, when the frequency is 10 MHz, the inductance is 106 nH. In the fourth line, when the frequency is 10 MHz, the inductance is 53 nH. In the fifth line, when the frequency is 10 MHz, the inductance is 72 nH.

From these, it can be seen that the inductance L is increased when the second layer 32 is provided and the second layer 32 is made of a material having a high permeability.

FIG. 14 is a graph showing Ploss/Pin of the first to fifth lines with respect to frequency. FIG. 14 shows a noise suppression indicator of the line. In FIG. 14, a horizontal axis represents the frequency, and a vertical axis represents Ploss/Pin. In FIG. 14, the frequency characteristic of the first line is indicated by a chain line, the frequency characteristic of the second line is indicated by a two-dot chain line, the frequency characteristic of the third line is indicated by a three-dot chain line, the frequency characteristic of the fourth line is indicated by a four-dot chain line, and the frequency characteristic of the fifth line is indicated by a five-dot chain line.

As shown in FIG. 14, in all of the first to fifth lines, Ploss/Pin is 0.6% or less at 10 MHz or less. When the frequency is 100 MHz, the third line has the highest Ploss/Pin of 8.9%, which is higher than Ploss/Pin of the second line in a band of 10 MHz to 400 MHz. At 800 MHz, the fifth line has the highest Ploss/Pin of 46%, which is larger than that of the fourth line in a band of 100 MHz to 1 GHz or less.

From these results, it can be seen that Ploss/Pin is increased at a particular frequency when the covering portion 30 has the first and second layers 31 and 32 and the soft magnetic material forming the second layer 32 is a material having a high permeability.

Also, in the present embodiment, the same effect as the present embodiment is obtained by an action of a proximity effect, even when an insulating layer is provided between the center conductor 20 and the first layer 31 in order to prevent diffusion of atoms or molecules or an insulating layer is provided between the first and second layers 31 and 32 in order to prevent diffusion of atoms or molecules.

Also, in the present embodiment, as an example of the configuration in which the covering portion 30 includes a plurality of layers, the configuration in which the covering portion 30 includes the first and second layers 31 and 32 has been described. The covering portion 30 may include three or more layers. Even in this case, the same effect as the present embodiment is obtained in such a manner that, in two layers contacting with each other, an anisotropic magnetic field of a soft magnetic material forming a layer disposed relatively inside is set to be higher than an anisotropic magnetic field of a soft magnetic material forming a layer disposed relatively outside.

Also, in the present embodiment, the easy axis of the uniaxial magnetic anisotropy of the first and second layers 31 and 32 is induced in the extending direction of the line. As another example, in only one of the first and second layers 31 and 32, the easy axis of the uniaxial magnetic anisotropy may be induced in the extending direction of the line. In this case, the same effect as the present embodiment is obtained. Likewise, in a case where the covering portion includes a plurality of layers, the same effect as the present embodiment is obtained because the easy axis of the uniaxial magnetic anisotropy of at least one of the plurality of layers is induced in the extending direction of the line.

Next, an inductor according to a third embodiment will be described with reference to FIGS. 15 to 17. Also, configurations having the same functions as the first embodiment are assigned with the same reference numerals as the first embodiment, and a description thereof will be omitted. In the present embodiment, a spiral inductor formed using the line 10 described in the first embodiment will be described below.

FIG. 15 is a perspective view showing the spiral inductor 50 of the present embodiment. As shown in FIG. 15, the spiral inductor 50 is configured on a substrate 40. A line configuring the spiral inductor 50 is the line 10 described in the first embodiment and has a rectangular cross-sectional shape as shown in FIG. 2.

The spiral inductor 50 has a rectangular outer shape, when viewed from the top surface, and has first to fourth edge portions 51 to 54. The first edge portion 51 and the third edge portion 53 face each other. Extending directions of the first and third edge portions 51 and 53 are parallel to each other. The second and fourth edge portions 52 and 54 face each other. Extending directions of the second and fourth edge portions 52 and 54 are parallel to each other. The extending direction of the first edge portion 51 and the extending direction of the second edge portion 52 are perpendicular to each other. The spiral inductor 50 is formed to extend along the first to fourth edge portions 51 to 54.

The easy axis of the uniaxial magnetic anisotropy of the spiral inductor 50 is induced in a single direction on a plane parallel to the surface of the substrate 40. Therefore, the spiral inductor 50 has a high-inductance and low-loss characteristic at a frequency lower than the frequency f1 at which the skin depth δ of the covering portion 30 and the thickness tm of the covering portion 30 become equal to each other.

In a case where the easy axis of the uniaxial magnetic anisotropy is induced in the spiral inductor 50, the spiral inductor 50 is cooled in a magnetic field applied in parallel to the single direction. In this manner, due to a magnetic field cooling effect, the easy axis of the uniaxial magnetic anisotropy can be induced in the single direction.

Next, regarding a first spiral inductor formed by the line having no covering portion 30 and having only the center conductor 20 as shown in FIG. 15 and a second and third spiral conductors formed by the line 10 having the covering portion 30 covered with CoNbZr, which is a soft magnetic material, the analysis results of inductances and Ploss/Pin will be described below. The second and third spiral inductors have the same configuration as the spiral inductor shown in FIG. 15.

A line width of the first spiral inductor is 0.102 mm. A thickness of the line is 0.102 mm. In the first to fourth edge portions 51 to 54, an interval of adjacent lines is 0.098 mm and is constant.

A line width of the center conductor 20 of the line width of the second and third spiral inductors is 0.1 mm. A thickness of the center conductor 20 is 0.1 mm. A thickness of the covering portion 30 is 1.0 μm. In the first to fourth edge portions 51 to 54, an interval of adjacent lines is 0.098 mm.

As described above, in the first to third spiral inductors, the line widths are equal to one another. Likewise, in the first to third spiral inductors, the line thicknesses are equal to one another. Likewise, in the first to third spiral inductors, the interval of adjacent lines in the first to fourth edge portions 51 to 54 are equal to one another.

In the present embodiment, the number of turns in the first to third spiral inductors is, for example, 3. In each of the first to third spiral inductors, the length of the line 10 disposed at the outermost side in the first edge portion 51 is longest. In the present embodiment, it is assumed that the length of the line disposed at the outermost side in the first edge portion 51 is 4 mm. It is assumed that a material of the substrate 40 is FR-4 and has a thickness of 1 mm.

In the second and third spiral inductors, the inducing direction of the axial magnetic anisotropy, that is, the relative permeability of each axis direction, is different. In the second spiral inductor, the easy axis of the uniaxial magnetic anisotropy is induced in the x-axis direction. Therefore, the x-axis, y-axis, and z-axis relative permeability (μx, μy, μz) is (1, μr, μr). The relative permeability μr is a complex relative permeability and has the frequency characteristic described in the first embodiment with reference to FIG. 5.

In the third spiral inductor, the easy axis of the uniaxial magnetic anisotropy is induced in a direction of 45 degrees with respect to the x-axis. Therefore, in the third spiral inductor, the easy axis of the uniaxial magnetic anisotropy may be induced in a direction of 45 degrees with respect to the y-axis. The x-axis, y-axis, and z-axis permeability (μx, μy, μz) of the third spiral inductor becomes (μr/√2, μr/√2, μr).

In the present embodiment, the x-axis and the y-axis are parallel to the surface 41 of the substrate 40, and the z-axis is perpendicular to the surface 41 of the substrate 40. The first and third edge portions 51 and 53 are parallel to the y-axis, and the second and fourth edge portions 52 and 54 are parallel to the x-axis.

FIG. 16 shows the inductances L of the first to third spiral inductors with respect to frequency. In FIG. 16, a horizontal axis represents the frequency, and a vertical axis represents the inductance. As shown in FIG. 16, when the frequency is 100 MHz or less, the second spiral inductor has an inductance of 145 nH or more, the third spiral inductor has an inductance of 195 nH or more, and the first spiral inductor has an inductance of 67 nH.

As such, the inductance of the second spiral inductor is 2.2 times the inductance of the first spiral inductor, and the inductance of the third spiral inductor is 2.9 times the inductance of the first spiral inductor.

FIG. 17 shows Ploss/Pin, which is a noise suppression indictor, with respect to frequency. In FIG. 17, a horizontal axis represents the frequency, and a vertical axis represents Ploss/Pin. In FIG. 17, a frequency characteristic of the first spiral inductor is indicated by a chain line, a frequency characteristic of the second spiral inductor is indicated by a two-dot chain line, and a frequency characteristic of the third spiral inductor is indicated by a three-dot chain line.

As shown in FIG. 17, in all of the first to third spiral inductors, Ploss/Pin is 0.8% or less at 10 MHz or less. Also, in the second and third spiral inductors, Ploss/Pin is 20% or more in a frequency band of 300 MHz to 1 GHz.

As in the second and third spiral inductors, the easy axis of the uniaxial magnetic anisotropy is induced with respect to the covering portion 30 in a single direction parallel to a plane (in the present embodiment, the surface 41 of the substrate 40) where the spiral inductors are disposed. Therefore, the spiral inductors have a high inductance value and a low Ploss/Pin in a low-frequency band used for signal transmission or power transmission, and has a high Ploss/Pin in a high-frequency band.

Also, the spiral inductors have a better characteristic by inducing the easy axis of the uniaxial magnetic anisotropy of the covering portion 30 in a direction of 45 degrees with respect to the x-axis and the y-axis.

Also, in the present embodiment, the line forming the spiral inductor used the line having the rectangular cross-sectional shape, which has been described in the first embodiment. As another example, the line having the circle-diameter cross-sectional shape, which has been described in the first embodiment, may be used. Alternatively, the line including the covering portion provided with the plurality of layers, which has been described in the second embodiment, may also be used. In these cases, the same effect as the present embodiment as obtained.

Next, an inductor according to a fourth embodiment will be described with reference to FIGS. 18 to 20. Also, in the present embodiment, configurations having the same functions as the first embodiment are assigned with the same reference numerals as the first embodiment, and a description thereof will be omitted. In the present embodiment, a meander inductor formed using the line 10 described in the first embodiment will be described below.

FIG. 18 is a plan view showing the meander inductor 60 of the present embodiment. The meander inductor 60 is formed by the line 10 having the rectangular cross-sectional shape, which has been described in the first embodiment. As shown in FIG. 18, the meander inductor has a plurality of long side portions 61. The plurality of long side portions 61 is disposed parallel to each other and is disposed such that intervals of the adjacent long side portions 61 are equal to each other. Ends of the adjacent long side portions 61 are connected to each other by short side portions 62. Therefore, the meander inductor 60 is formed such that the line 10 is connected as one. The short side portions 62 are perpendicular to the long side portions 61. The short side portions 62 are parallel to each other.

In the soft magnetic material forming the covering portion 30 of the line 10 of the meander inductor 60, the easy axis of the uniaxial magnetic anisotropy is induced in the extending direction of the long side portion 61. The meander inductor is cooled in a magnetic field applied in a direction parallel to the long side portion 61. Thus, due to a magnetic field cooling effect, the easy axis of the uniaxial magnetic anisotropy is induced in the extending direction of the long side portion 61.

As shown in FIG. 18, the meander inductor 60 is fixed on a substrate 40. As another example, the meander inductor may be fixed on a semiconductor wiring layer. Alternatively, the meander inductor may be fixed in a state of being suspended in the air.

Next, regarding a first meander inductor formed by the line having no covering portion 30 and having only the center conductor 20 and a second meander inductor formed by the line 10 having the covering portion 30, the analysis results of inductances and Ploss/Pin with respect to frequency will be described below. The second meander inductor has the same configuration as the meander inductor shown in FIG. 18.

A width of the line forming the first meander inductor is 0.102 mm. In the first meander inductor, an interval of adjacent long side portions 61 is 0.098 mm. In the first meander inductor, a thickness of the line is 0.102 mm.

A width of the line 10 forming the second meander inductor is 0.1 mm. A thickness of the line 10 is 0.1 mm. A thickness of the covering portion 30 of the line 10 is 1 μm. An interval of adjacent long side portions 61 of the second meander inductor is 0.09 mm. As such, the shapes of the first and second meander inductors are identical to each other. The first and second meander inductors have four long side portions 61. A material of the substrate 40 is FR-4. A thickness of the substrate 40 is 1 mm.

In the second meander inductor, the uniaxial magnetic anisotropy is induced in the extending direction of the long side portions 61. In the present embodiment, the long side portions 61 extend in parallel to the x-axis. Therefore, the x-axis, y-axis, and z-axis permeability (μx, μy, μz) of the second meander inductor becomes (1, μr, μr). Also, the relative permeability μr is a complex relative permeability and has the frequency characteristic described in the first embodiment with reference to FIG. 5.

FIG. 19 is a graph showing the inductance with respect to the frequency. In FIG. 19, a horizontal axis represents the frequency, and a vertical axis represents the inductance. In FIG. 19, a frequency characteristic of the first meander inductor is indicated by a chain line, and a frequency characteristic of the second meander inductor is indicated by a two-dot chain line.

As shown in FIG. 19, the inductance of the first meander inductor is constantly 8.6 nH. When the frequency is 120 MHz or less, the inductance of the second meander inductor 96 nH or more, and is more than 11 times the inductance of the first meander inductor.

FIG. 20 shows Ploss/Pin, which is a noise suppression indictor, with respect to frequency. In FIG. 20, a horizontal axis represents the frequency, and a vertical axis represents Ploss/Pin. In FIG. 20, a frequency characteristic of the first meander inductor is indicated by a chain line, and a frequency characteristic of the second meander inductor is indicated by a two-dot chain line.

As shown in FIG. 20, in the second meander inductor, Ploss/Pin increases when the frequency exceeds 30 MHz, and Ploss/Pin is 34% or more in a band of 300 MHz to 1 GHz. As such, the second meander inductor has a characteristic that the inductance value increases in a low-frequency band used for signal transmission or power transmission and Ploss/Pin decreases, and has a characteristic that Ploss/Pin increases in a high-frequency band that becomes noise.

Also, in the present embodiment, the line forming the meander inductor used the line having the rectangular cross-sectional shape, which has been described in the first embodiment. As another example, the line having the circle-diameter cross-sectional shape, which has been described in the first embodiment, may be used. Alternatively, the line including the covering portion provided with the plurality of layers, which has been described in the second embodiment, may also be used. In these cases, the same effect as the present embodiment is obtained.

Next, an inductor according to a fifth embodiment will be described with reference to FIGS. 21 and 22. Also, configurations having the same functions as the first embodiment are assigned with the same reference numerals as the first embodiment, and a description thereof will be omitted. In the present embodiment, a solenoid coil formed using the line 10 described in the first embodiment will be described below. The solenoid coil is an example of an inductor.

FIG. 21 is a perspective view showing the solenoid coil 70. In the present embodiment, the solenoid coil 70 is supported on the substrate 40. In the present embodiment, in the solenoid coil 70, the easy axis of the uniaxial magnetic anisotropy is induced in a winding direction. Also, in FIG. 21, the winding direction is indicated by an arrow F21. The solenoid coil is cooled while a current flows along a center line C of the solenoid coil 70. Thus, due to a magnetic field cooling effect, the easy axis of the uniaxial magnetic anisotropy may be induced in the winding direction F20.

Next, regarding a first solenoid coil and a second solenoid coil, the analysis result of inductance and Ploss/Pin with respect to frequency will be described.

The first solenoid coil is formed by a line having only a center conductor made of copper (Cu) and having no covering portion. The cross-sectional shape of the line of the first solenoid coil is a square in which a length of one side is 0.102 mm, a pitch of the line is 0.2 mm, and the number of turns is 4. An inner diameter of the first solenoid coil is 0.399 mm.

The second solenoid coil is formed by the line 10 described in the first embodiment. The cross-sectional shape of the center conductor 20 is a square in which a length of one side is 0.1 mm, the covering portion 30 is made of CoNbZr as a soft magnetic field, and a thickness thereof is constantly 1.0 μm. A pitch of the second solenoid coil is 0.2 mm. The number of turns in the second solenoid coil is 4.

As such, the shapes of the first and second solenoid coils are identical to each other. Both of the first and second solenoid coils are fixed on the substrate. The substrate is made of FR-4.

The relative permeability of the covering portion of the second solenoid coil induces the easy axis of the uniaxial magnetic anisotropy in the winding direction. Therefore, the x-axis, y-axis, and z-axis permeability (μx, μy, μz) becomes (μr, μr, μr). Also, the relative permeability μr is a complex relative permeability and has the frequency characteristic described in the first embodiment with reference to FIG. 5.

FIG. 22 is a graph showing inductances of the first and second solenoid coils with respect to frequency. In FIG. 22, a horizontal axis represents the frequency, and a vertical axis represents the inductance. In FIG. 22, a frequency characteristic of the first solenoid coil is indicated by a chain line, and a frequency characteristic of the second solenoid coil is indicated by a two-dot chain line.

As shown in FIG. 22, the inductance of the first solenoid coil is 12 nH and is approximately constant. On the other hand, the inductance of the second solenoid coil is 40 nH or more when the frequency is 100 MHz or less.

FIG. 23 shows Ploss/Pin that is a noise suppression indictor. In FIG. 23, a horizontal axis represents the frequency, and a vertical axis represents Ploss/Pin. In FIG. 23, a frequency characteristic of the first solenoid coil is indicated by a chain line, and a frequency characteristic of the second solenoid coil is indicated by a two-dot chain line.

As illustrated in FIG. 23, in both of the first and second solenoid coils, Ploss/Pin is 0.8% or less when the frequency is 10 MHz or less. Also, in the second solenoid coil, Ploss/Pin is 30% or more in a frequency band of 300 MHz to 1 GHz.

As described above, it can be seen that the second solenoid coil has a characteristic that has a high inductance value and a low Ploss/Pin in a low-frequency band used for signal transmission or power transmission and has a high Ploss/Pin in a high-frequency band that becomes noise.

Also, in the present embodiment, the line forming the solenoid coil used the line having the rectangular cross-sectional shape, which has been described in the first embodiment. As another example, the line having the circle-diameter cross-sectional shape, which has been described in the first embodiment, may be used. Alternatively, the line including the covering portion provided with the plurality of layers, which has been described in the second embodiment, may also be used. In these cases, the same effect as the present embodiment is obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A line comprising:
a center conductor; and
a covering portion which covers the center conductor, the covering portion including at least one layer that is made of a soft magnetic material and is thinner than a skin depth at a frequency where supply of a signal or power is performed.

2. The line according to claim 1, wherein when the covering portion includes only one layer, an easy axis of a uniaxial magnetic anisotropy of the covering portion is induced in a longitudinal direction of the line.

3. The line according to claim 1, wherein when the covering portion includes two or more layers, an easy axis direction of a uniaxial magnetic anisotropy of at least one layer is induced in a longitudinal direction of the line.

4. The line according to claim 1, wherein a ferromagnetic resonance frequency of the soft magnetic material is higher than a frequency at which the skin depth and a thickness of the soft magnetic material become equal to each other.

5. The line according to claim 1, wherein a magnetic field intensity applied due to a current flowing through the center conductor is equal to or less than an anisotropic magnetic field intensity of the soft magnetic material.

6. The line according to claim 1, wherein when the covering portion includes two or more layers, in two layers contacting with each other, an anisotropic magnetic field of a soft magnetic material forming a layer disposed relatively inside is higher than an anisotropic magnetic field of a soft magnetic material forming a layer disposed relatively outside.

7. A spiral inductor comprising:
a center conductor; and
a covering portion which covers the center conductor, the covering portion including at least one layer that is made of a soft magnetic material and is thinner than a skin depth at a frequency where supply of a signal or power is performed.

8. A meander inductor comprising:
a center conductor; and
a covering portion which covers the center conductor, the covering portion including at least one layer that is made of a soft magnetic material and is thinner than a skin depth at a frequency where supply of a signal or power is performed.

9. A solenoid coil comprising:
a center conductor; and
a covering portion which covers the center conductor, the covering portion including at least one layer that is made of a soft magnetic material and is thinner than a skin depth at a frequency where supply of a signal or power is performed.
